(19) United States
(12) Patent Application Publication
(10) Pub. No.: US 2017/0228707 A1
(43) Pub. Date: Aug. 10, 2017

(54) SYSTEM AND METHOD FOR MAKING A DEPOSIT WITH A DEPOSITORY INSTITUTION

(71) Applicant: MasterCard International Incorporated, Purchase, NY (US)

(72) Inventor: Pravin Parekh, Maharashtra (IN)

(21) Appl. No.: 15/423,801

(22) Filed: Feb. 3, 2017

(30) Foreign Application Priority Data
Feb. 4, 2016 (SG) 10201600857P

(51) Int. Cl. G06Q 20/10; G06Q 20/26

(52) U.S. Cl. CPC G06Q 20/10; G06Q 20/26

(57) ABSTRACT

There is provided a method, platform and system for making a monetary deposit with a depository institution. In at least some embodiments, the method, platform and system allow users to gain access to preferential rates for their monetary deposits, and can also provide a channel for some depository institutions to provide monetary deposit products/services for the users, whereby these depository institutions could not or did not provide such monetary deposit products/services in the past.

### CROSS-REFERENCE TO RELATED APPLICATION

This application is a U.S. National Stage filing under 35 U.S.C. §119, based on and claiming benefit of and priority to SG Patent Application No. 10201600857P filed Feb. 4, 2016.

### TECHNICAL FIELD

Embodiments of the present invention relate to a platform, method and system for making a monetary deposit with a depository institution.

### BACKGROUND

Traditionally, only financial institutions could provide financial services to consumers, and the consumers typically need to be customers of the financial institutions in order to gain access to the financial services which were offered by the financial institutions. In addition, the financial institutions would typically only pander to the needs of a minority group of customers who provided them with the best profits by offering these customers preferential savings and loan rates, whereby the majority group of customers did not have access to any preferential services/products.

There are an increasing number of corporate entities who are traditionally not in the business of providing financial services to consumers, but who now provide electronic wallets to consumers to provide additional conveniences for their customers. Examples of such corporate entities include telecommunications companies, supermarket companies, retail companies, and so forth. With the provision of such electronic wallets to their customers, the corporate entities now have ready access to a pool of funds belonging to their customers. However, the consumers have to manage the plurality of electronic wallets in their possession, and they typically do not become preferential customers as their spending through the respective electronic wallets is not substantial.

There are some problems in relation to the business practices of traditional financial institutions, and the disparate nature of electronic wallets.

### SUMMARY

In a first aspect, there is provided a system for making a monetary deposit at a depository institution server. The system comprises at least one computing device configured for receiving instructions from a user; a payment gateway communicatively coupled to the at least one computing device; and at least one data aggregator for aggregating monetary deposit offers from the payment gateway, the at least one data aggregator being communicatively coupled to the at least one computing device. It is advantageous that the at least one data aggregator is configured to aggregate monetary deposit offers upon receipt of the instructions from the at least one computing device, the instructions including parameters pertaining to the monetary deposit, and parameters of prior monetary deposits associated with the user obtained from the payment gateway.

It is preferable that the payment gateway includes a data storage device configured to store the parameters, the parameters being the monetary deposit amount and tenure of the monetary deposit.

In a second aspect, there is provided a server configured for making a monetary deposit at a depository institution server. The server is configured to carry out a method comprising receiving from a user device, parameters pertaining to the monetary deposit; obtaining updated deposit offers from respective servers of a plurality of depository institutions; presenting to the user device, the updated deposit offers; receiving from the user device, a request for improved deposit offers; providing the respective servers of the plurality of depository institutions with information to obtain the improved deposit offers, the information being obtained from a payment gateway; obtaining the improved deposit offers from the respective servers of the plurality of depository institutions; and processing the improved deposit offers and presenting to the user device, the improved deposit offers from the respective servers of the plurality of depository institutions. Preferably, the information includes the parameters pertaining to the monetary deposit and parameters of prior monetary deposits associated with a particular user.

The server being configured to carry out the method can further comprise receiving at least one selection from the user device from amongst the improved deposit offers; sending a request to the payment gateway to seek monies for the monetary deposit; receiving a debit request from the payment gateway; and receiving a confirmation of the monetary deposit from the server of at least one depository institution.

Preferably, the payment gateway includes a data storage device configured to store the parameters, the parameters being the monetary deposit amount and tenure of the monetary deposit.

In another aspect, there is provided a platform for making a monetary deposit with a depository institution. The platform comprises an instruction input module configured for receiving instructions pertaining to the monetary deposit from a user; and a data aggregation module communicatively coupled to the instruction input module. Preferably, the data aggregation module is configured to aggregate data from a payment gateway upon receipt of the instructions, the instructions including parameters pertaining to the monetary deposit and parameters of prior monetary deposits associated with the user.

The platform can further comprise an information display module communicatively coupled to the data aggregation module; and a monetary fund transfer module communicatively coupled to the instruction input module.

It is preferable that the information display module is configured to display the data provided to the data aggregation module by the servers of the plurality of depository institutions, the parameters being the monetary deposit amount and tenure of the monetary deposit.

In a further aspect, there is provided a data processor implemented method for making a monetary deposit at a depository institution server. The method comprises receiving from a user device, parameters pertaining to the monetary deposit; obtaining updated deposit offers from respective servers of a plurality of depository institutions; presenting to the user device, the updated deposit offers; receiving from the user device, a request for improved deposit offers; providing the respective servers of the plurality of depository institutions with information to obtain the improved deposit offers, the information being obtained from a payment gateway; obtaining the improved deposit offers from the respective servers of the plurality of depository institutions; processing the improved deposit offers and presenting to the user device, the improved deposit offers from the respective servers of the plurality of depository institutions. It is preferable that the information includes the parameters pertaining to the monetary deposit and parameters of prior monetary deposits associated with a particular user.

The data processor implemented method can further comprise receiving at least one selection from the user device from amongst the improved deposit offers;

sending a request to the payment gateway to seek monies for the monetary deposit; receiving a debit request from the payment gateway; and receiving a confirmation of the monetary deposit from the server of at least one depository institution.

Preferably, the payment gateway includes a data storage device configured to store the parameters, the parameters being the monetary deposit amount and tenure of the monetary deposit.

There is also provided a non-transitory computer readable storage medium embodying thereon a program of computer readable instructions which, when executed by one or more processors of a server in communication with at least one user device, cause the server to perform a method for making a monetary deposit with a depository institution server. The method embodies the steps of receiving from the user device, parameters pertaining to the monetary deposit; obtaining updated deposit offers from respective servers of a plurality of depository institutions; presenting to the user device, the updated deposit offers; receiving from the user device, a request for improved deposit offers; providing the respective servers of the plurality of depository institutions with information to obtain the improved deposit offers, the information being obtained from a payment gateway; obtaining the improved deposit offers from the respective servers of the plurality of depository institutions; and processing the improved deposit offers and presenting to the user device, the improved deposit offers from the respective servers of the plurality of depository institutions. Preferably, the information includes the parameters pertaining to the monetary deposit and parameters of prior monetary deposits associated with a particular user.

The storage medium can further embody steps comprising receiving at least one selection from the user device from amongst the improved deposit offers; sending a request to the payment gateway to seek monies for the monetary deposit;

receiving a debit request from the payment gateway; and receiving a confirmation of the monetary deposit from the depository institution server.

Preferably, the payment gateway includes a data storage device configured to store the parameters, the parameters being the monetary deposit amount and tenure of the monetary deposit.

In a final aspect, there is provided a non-transitory computer readable storage medium embodying thereon a program of computer readable instructions which, when executed by one or more processors of a mobile device in communication with at least one other server, cause the mobile device to perform a method for making a monetary deposit with a depository institution server. The method embodies the steps of receiving parameters pertaining to the monetary deposit; obtaining from the at least one server, updated deposit offers from respective servers of a plurality of depository institutions; presenting the updated deposit offers; receiving a request for improved deposit offers; providing, via the at least one server, to the respective servers of the plurality of depository institutions with information to obtain the improved deposit offers, the information being obtained from a payment gateway; obtaining, via the at least one server, the improved deposit offers from the respective servers of the plurality of depository institutions; and presenting the improved deposit offers from the respective servers of the plurality of depository institutions. It is preferable that the information includes the parameters pertaining to the monetary deposit and parameters of prior monetary deposits associated with a particular user.

The storage medium can further embody steps comprising receiving at least one selection from amongst the improved deposit offers; sending a request to the payment gateway to seek monies for the monetary deposit; receiving a debit request from the payment gateway; and receiving a confirmation of the monetary deposit from a server of the at least one depository institution.

It is preferable that the payment gateway includes a data storage device configured to store the parameters, the parameters being the monetary deposit amount and tenure of the monetary deposit.

### DESCRIPTION OF FIGURES

In order that the present invention may be fully understood and readily put into practical effect, there shall now be described by way of non-limitative example only, certain embodiments of the present invention, the description being with reference to the accompanying illustrative figures, in which:

FIGS. 1A and 1B show a schematic overview of a method according to certain embodiments of the present invention.

FIG. 2 shows a process flow of a data processor implemented method according to certain embodiments of the present invention.

FIG. 3 shows a schematic view of a user device used in the method shown in FIG. 2.

FIG. 4 shows a schematic view of a server used in the method shown in FIG. 2.

FIG. 5 shows an overview of a system according to certain embodiments of the present invention.

FIG. 6 shows a schematic view of a platform according to certain embodiments of the present invention.

### DETAILED DESCRIPTION

There is provided a method, platform and system for making a monetary deposit with a depository institution. In at least some embodiments, the method, platform and system allow users to gain access to preferential rates for their monetary deposits, and can also provide a channel for some depository institutions to provide monetary deposit products/services for the users, whereby these depository institutions could not or did not provide such monetary deposit products/services in the past. Some of these depository institutions which could not or did not provide such monetary deposit products/services in the past include, for example, telecommunications companies, supermarket companies, retail companies, and so forth. In addition, the method, platform and system may lead to effective engagement between the depository institutions and the users. It should be appreciated that a natural person is not a depository institution.

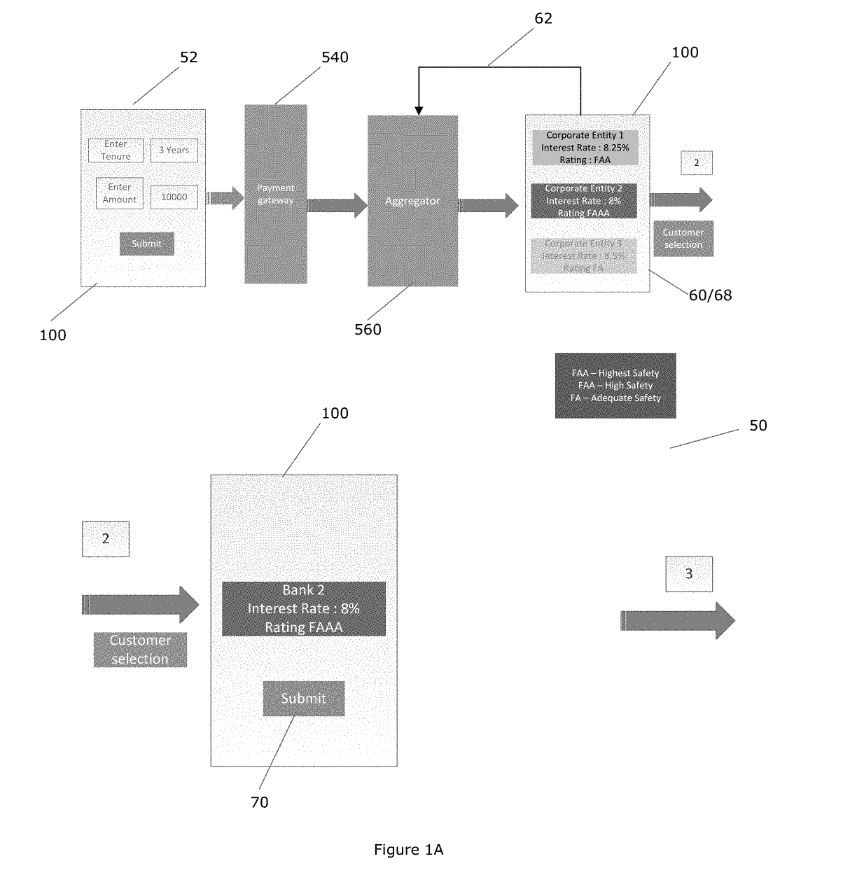

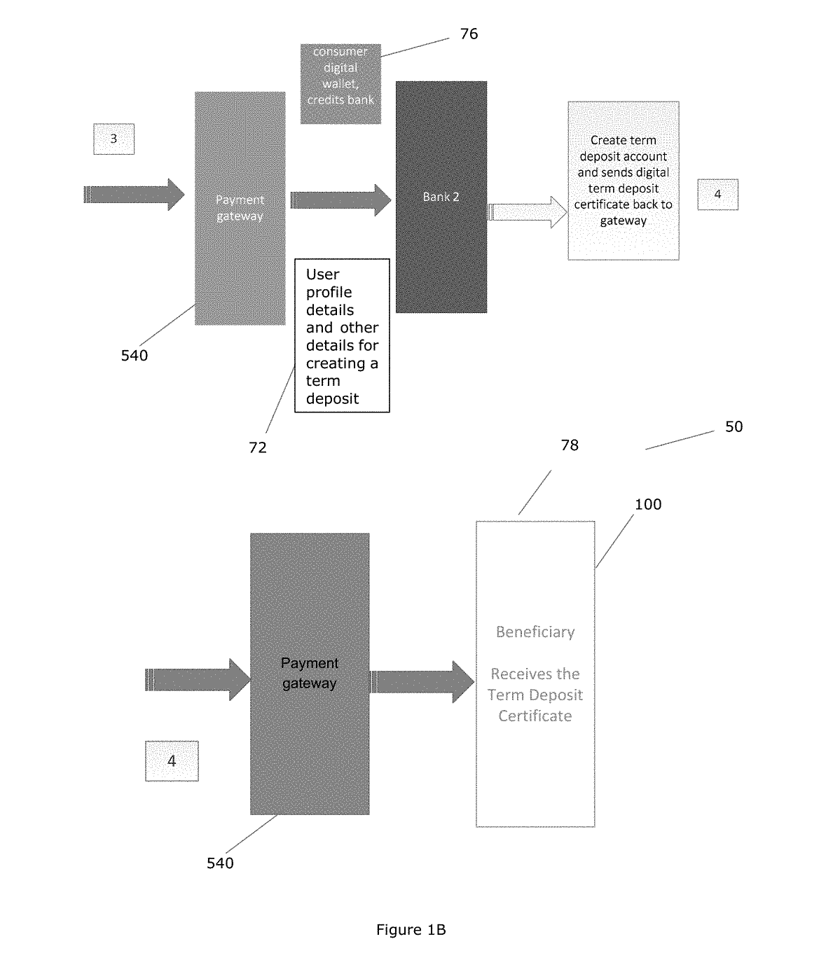

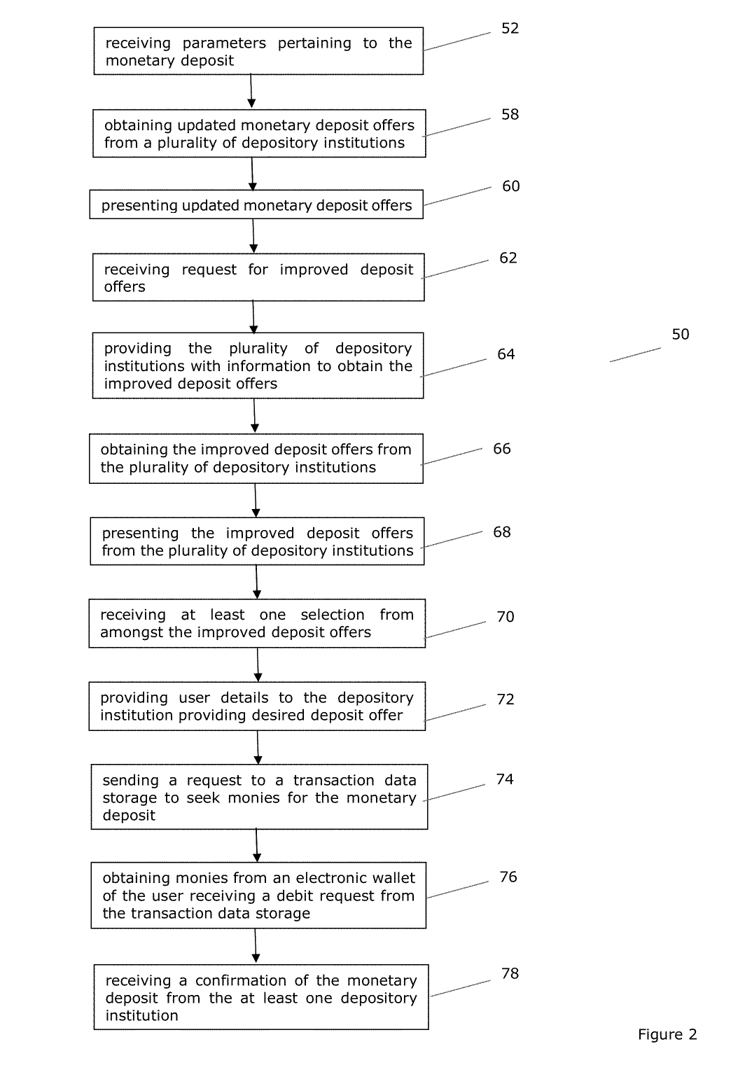

FIG. 2 shows the steps of an exemplary method 50, while FIG. 1 shows a context in which the steps are carried out. The method 50 will be depicted in a flow diagram (FIG. 2), and each of the blocks of the flow diagram may be executed by a data processor(s) or a portion of the data processor (for example, a single core of a multi-core processor). The processes may be embodied in a non-transient machine-readable and/or computer-readable medium for configuring a computer system to execute the method. A software module(s) may be stored within and/or transmitted to a computer system memory to configure the computer system to carry out the tasks indicated in each of the blocks of the flow diagram.

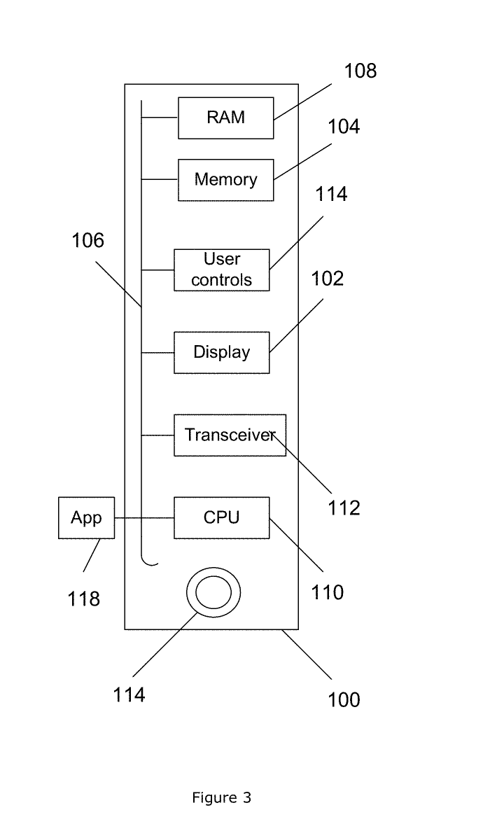

The method 50 can be carried out on a mobile device 100. The mobile device 100 is a handheld device such as a smartphone or a tablet computer such as one manufactured by Apple™, LG™, HTC™, Samsung™, and Motorola™. An exemplary embodiment of the mobile device 100 is shown in FIG. 3. As shown, the device 100 includes the following components in electronic communication via a bus 106:

a display 102;

non-volatile memory 104;

random access memory (“RAM”) 108;

N processing components 110;

a transceiver component 112 that includes N transceivers; and

user controls 114.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 102 generally operates to provide a presentation of content to a user, and may be realized by any of a variety of displays (e.g., CRT, LCD, HDMI, micro-projector and OLED displays). And in general, the non-volatile memory 104 functions to store (e.g. persistently store) data and executable code including code that is associated with the functional components of the method. In some embodiments, for example, the non-volatile memory 104 includes bootloader code, modem software, operating system code, file system code, and code to facilitate the implementation of one or more portions of the method as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104 to effectuate the functional components. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

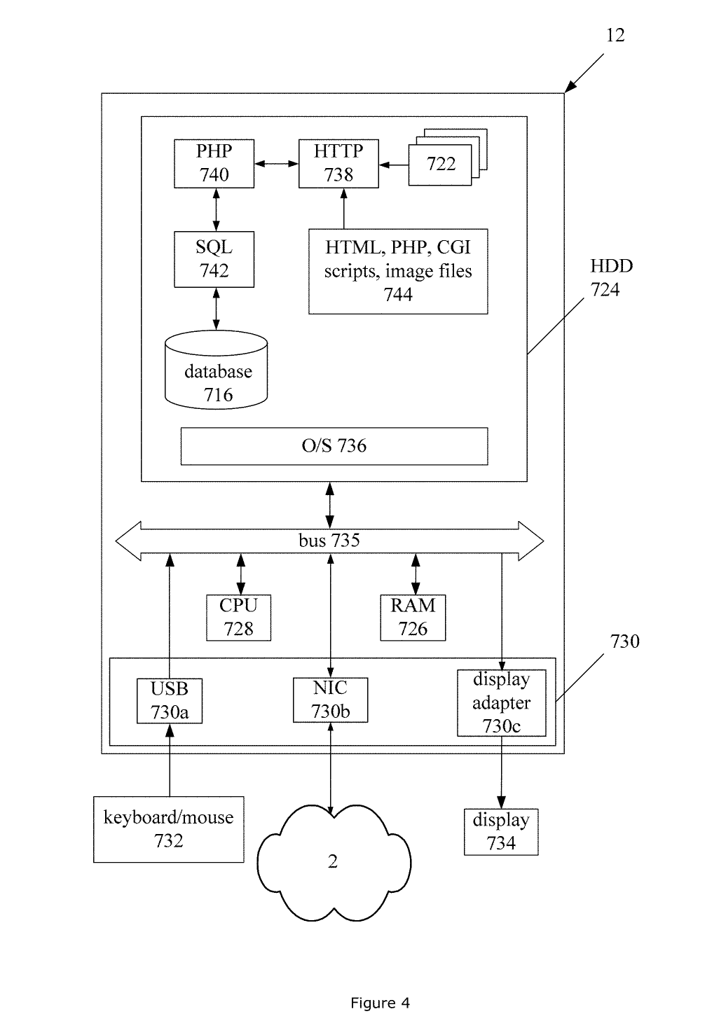

The method 50 can also be carried out by a server 12 as shown in FIG. 4. The server 12 is able to communicate with the mobile device 100 over a communications network 2 using standard communication protocols.

It should be appreciated that the method 50 can be configured to be performed in a variety of ways. The steps can be implemented entirely by software to be executed on standard computer server hardware, which may comprise one hardware unit or different computer hardware units distributed over various locations, some of which may require the communications network 2 for communication. A number of the components or parts thereof may also be implemented by application specific integrated circuits (ASICs) or field programmable gate arrays.

In FIG. 4, the server 12 is a commercially available server computer system based on a 32 bit or a 64 bit Intel architecture, and the processes and/or methods executed or performed by the computer server 12 are implemented in the form of programming instructions of one or more software components or modules 722 stored on non-volatile (e.g., hard disk) computer-readable storage 724 associated with the server 12. At least parts of the software modules 722 could alternatively be implemented as one or more dedicated hardware components, such as application-specific integrated circuits (ASICs) and/or field programmable gate arrays (FPGAs).

The server 12 includes at least one or more of the following standard, commercially available, computer components, all interconnected by a bus 735:

1. random access memory (RAM) 726;

2. at least one computer processor 728, and

3. external computer interfaces 730:

a. universal serial bus (USB) interfaces 730a (at least one of which is connected to one or more user-interface devices, such as a keyboard, a pointing device (e.g., a mouse 732 or touchpad),

b. a network interface connector (NIC) 730b which connects the server 12 to a data communications network, such as the Internet 2; and

c. a display adapter 730c, which is connected to a display device 734 such as a liquid-crystal display (LCD) panel device.

The server 12 includes a plurality of standard software modules, including:

1. an operating system (OS) 736 (e.g., Linux or Microsoft Windows);

2. web server software 738 (e.g., Apache, available at http://www.apache.org);

3. scripting language modules 740 (e.g., personal home page or PHP, available at http://www.php.net, or Microsoft ASP); and

4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the server 12 with the general ability to allow users of the Internet 2 with mobile device 100 equipped with standard web browser software to access the server 12 and in particular to provide data to and receive data from the database 716. It will be understood by those skilled in the art that the specific functionality provided by the server 12 to such users is provided by scripts accessible by the web server 738, including the one or more software modules 722 implementing the processes performed by the server 12, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention.

Alternatively, such actions may be embodied in the structure of circuitry that implements such functionality, such as the micro-code of a complex instruction set computer (CISC), firmware programmed into programmable or erasable/programmable devices, the configuration of a field- programmable gate array (FPGA), the design of a gate array or full-custom application-specific integrated circuit (ASIC), or the like.

Each of the blocks of the flow diagrams of the processes of the server 12 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 12 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Referring to FIGS. 1A, 1B and 2, there is provided a data processor implemented method 50 for making a monetary deposit with a depository institution. FIGS. 1A and 1B depict both steps of the method 50 and physical components used in the method 50, while FIG. 2 depicts only the steps of the method 50. For the sake of clarity, it should be appreciated that FIGS. 1A and 1B depict an embodiment of how the physical components carry out the steps of the method 50. It should be noted that the depository institution need not be a bank or financial institution. The method 50 can be carried out as a supplementary service to an electronic wallet facility, or can also be a standalone service tied to an electronic wallet facility.

The method 50 comprises receiving parameters pertaining to the presently offered monetary deposit (52). The parameters can be input using, for example, a digital wallet/an app on a mobile device 100 or a web browser on a computer. The parameters which are received can include the monetary deposit amount and tenure of the monetary deposit. The parameters determine choices of monetary deposit products which will be provided to the user for consideration. The parameters are sent to a payment gateway 540 and an aggregator 560 obtains updated monetary deposit offers from respective servers of a plurality of depository institutions (58). The payment gateway 540 can include a data storage server which stores the parameters transmitted to the payment gateway 540. The aggregator 560 can be provided regular feeds of updated monetary deposit offers from the respective servers of the plurality of depository institutions. The aggregator 560 can be part of the server 12, and tasks of the aggregator 560 can be executed by the modules 722 of the server 12.

The updated deposit offers are then presented (60), for example, via a digital wallet/application executing on a mobile device 100 or via a web browser executing on a laptop or desktop computer. The updated deposit offers can include, for example, tenure, interest rate, and credit rating for each of the plurality of depository institutions. The credit rating can be a qualitative assessment determined by an organisation such as a ratings agency with access to data pertaining to the plurality of depository institutions, such as, for example, historical financial performance, current financial state, and so forth. Credit rating data for the corporate entities may be retrieved automatically, for example by aggregator 56, from a server operated by the ratings agency.

The method 50 can include receiving a request for improved deposit offers (62). This typically occurs during instances when users are not content with the deposit offers which are provided for their consideration and wish to seek more desirable offers. Alternatively, the request for improved deposit offers occurs during instances when users seek monetary deposit offers for amounts above a pre-determined quantum. Subsequently, the method 50 includes providing the respective servers of the plurality of depository institutions with information to obtain the improved deposit offers (64). The information provided to the respective servers of the plurality of depository institutions can include, for example, the parameters pertaining to the presently offered monetary deposit and parameters of prior monetary deposits associated with a particular user. It should be appreciated that the parameters of prior monetary deposits can be obtained from the payment gateway 540. The payment gateway 540 is configured to obtain the parameters of prior monetary deposits from the aggregator 560. The aggregator 560 is configured to obtain the parameters of prior monetary deposits from the data storage server of the payment gateway 540. The data storage server of the payment gateway 540 is also configured to store the parameters of prior monetary deposits. The provision of the information to the plurality of depository institutions provides the depository institutions data to assess if it would be worthwhile to offer more desirable monetary deposit offers so as to potentially capture the quantum of at least one prior monetary deposit.

In some embodiments, the method 50 then includes obtaining the improved deposit offers from the respective servers of the plurality of depository institutions (66) and presenting the improved deposit offers from the plurality of depository institutions (68). Similar to a prior step of the method 50, the improved deposit offers can be provided for example, via a digital wallet/application executing on a mobile device 100 or via a web browser executing on a laptop or desktop computer. The updated deposit offers can include, for example, tenure, interest rate, credit rating for each of the plurality of depository institutions.

Furthermore, the method 50 can also include receiving at least one selection from amongst the improved deposit offers (70). The at least one selection can be received via, for example, a digital wallet/application executing on a mobile device 100 or via a web browser executing on a laptop or desktop computer. The receiving of the at least one selection also includes transmitting data about the user such that the server of the depository institution providing the selected deposit offer is able to carry out requisite administrative processes (for example, obtaining identification of the user, obtaining contact details of the user, verification procedures to identify the user and the like) to provide the selected deposit offer to the user (72). This can also be received via, for example, a digital wallet/application executing on a mobile device 100 or via a web browser executing on a laptop or desktop computer. It should be appreciated that the data about the user can be input by the user. The user data may be stored on the user's mobile device 100 for access by the digital wallet application or any other application executing on the device 100.

Then, the method 50 includes sending a request to the payment gateway 540 to seek monies for the presently offered monetary deposit (74) for transmission to the server of the depository institution providing the desired monetary deposit offer. It should be appreciated that each depository institution will need to be associated with a bank or financial institution at the payment gateway 540. In some embodiments, the payment gateway 540 can include an association table defining ties or relationships between each depository institution and a bank/financial institution. Eventually, the monies are obtained from an electronic wallet of the user receiving a debit request from the payment gateway 540 (76). Finally, the method 50 includes receiving a confirmation of the presently offered monetary deposit from the server of the at least one depository institution (78), the confirmation being an indication that the presently offered monetary deposit has been initiated such as, for example, a printed certificate, a digital certificate and so forth. This confirmation can also be received via, for example, a digital wallet/application executing on a mobile device 100 or via a web browser executing on a laptop or desktop computer.

It should be appreciated that the method 50 can be carried out via an interface in an e-wallet application executing on the mobile device 100 or a web browser executing on a laptop or desktop computer, where all processing is carried out on the server 12 interfacing with the application executing on a mobile device 100.

Alternatively, the method 50 can be carried out entirely on the mobile device 100 where processing capabilities of the mobile device 100 ensure that the requisite security and responsiveness (in relation to processing times such that lag is not an issue) requirements are met.

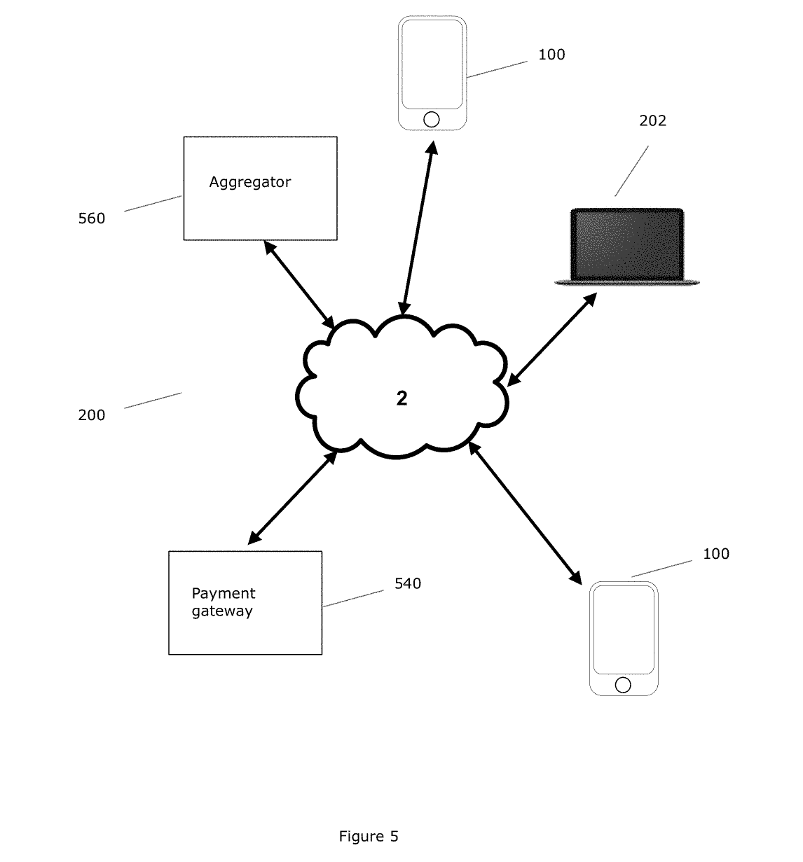

Referring to FIG. 5, there is shown a system 200 for making a monetary deposit with a depository institution. The method 50 can be carried out using the system 200. The system 200 comprises at least one computing device 100/202 configured for receiving instructions from a user. The instructions can include parameters pertaining to the presently offered monetary deposit and parameters of prior monetary deposits associated with the user. The parameters are the monetary deposit amount and tenure of the monetary deposit.

The mobile device 100 or computer 202 can be the at least one computing device. The mobile device 100 and the computer 202 can respectively have an application executing on the mobile device 100, or a web browser configured to receive instructions from the user.

The system 200 can also include a payment gateway 540 communicatively coupled to the at least one computing device 100/202. As described earlier, the payment gateway 540 can include a data storage server which stores the parameters transmitted to the payment gateway 540. In addition, the system 200 includes at least one data aggregator 560 for aggregating monetary deposit offers from the data storage server of the payment gateway 540, whereby the at least one data aggregator 560 is configured to aggregate monetary deposit offers upon receipt of the instructions from the user.

As shown in FIG. 5, the various components of the system 200 are communicatively coupled to each other over communications network 2.

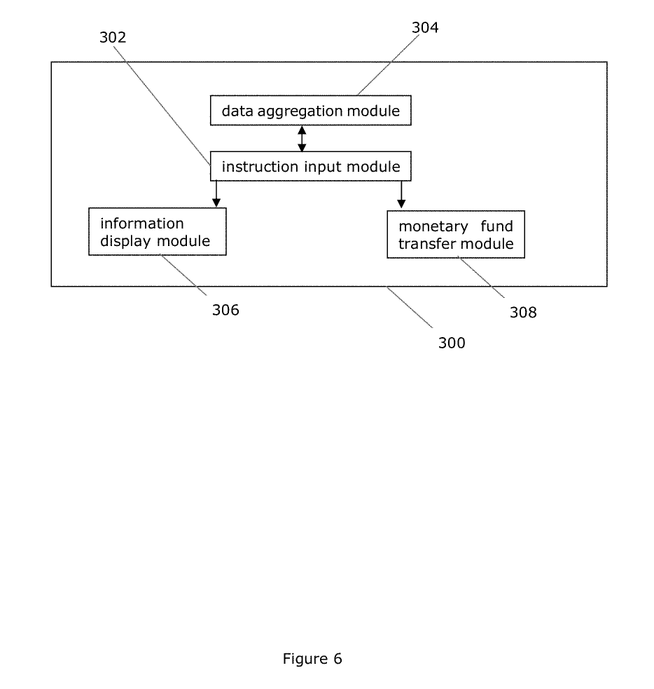

Referring to FIG. 6, there is also shown an alternative representation of the system 200 in a form of a platform 300 for making a monetary deposit with a depository institution server. Modules of the platform 300 can be part of components of the system 200. It should appreciated that the platform 300 can facilitate the carrying out of the method 50 and can be hosted on the server 12, or partially hosted on the server 12. It should also be appreciated that the platform 300 can be supported by the system 200. The platform 300 can also be configured to operate with electronic wallet systems.

The platform 300 comprises an instruction input module 302 configured for receiving instructions pertaining to the presently offered monetary deposit from a user. The instruction input module 302 can be an application executing on the mobile device 100 or a web browser executing on the computer 202. For example, steps 52, 62, 70 of the method 50 can be carried out using the instruction input module 302. The instructions can include, for example, parameters pertaining to the presently offered monetary deposit and parameters of prior monetary deposits associated with the user. The parameters can include the monetary deposit amount and tenure of the monetary deposit. The provision of the instructions to respective servers of the plurality of depository institutions provides the depository institutions data to assess if it would be worthwhile to offer more desirable monetary deposit offers so as to potentially capture the quantum of at least one prior monetary deposit.

The platform 300 also includes a data aggregation module 304 communicatively coupled to the instruction input module 302, whereby the data aggregation module 304 is configured to aggregate data upon receipt of the instructions. The data aggregation module 304 is configured to obtain the requisite data from a data storage server of a payment gateway. For example, steps 58, 64, 66, 72 of the method 50 can be carried out using the data aggregation module 304. The data of monetary deposit offers is provided to the data aggregation module 304 by the respective servers of the plurality of depository institutions. The data can include monetary deposit offers that include, for example, tenure, interest rate, credit rating for each of the plurality of depository institutions. The credit rating can be a qualitative assessment determined by an organisation with access to data pertaining to the plurality of depository institutions, such as, for example, historical financial performance, current financial state, and so forth.

In addition, the platform 300 also includes an information display module 306 communicatively coupled to the data aggregation module 304. The information display module 306 is configured to display the data provided to the data aggregation module 304 by the respective servers of the plurality of depository institutions. For example, steps 60, 68, 78 of the method 50 can be carried out using the information display module 306.

Finally, the platform 300 also includes a monetary fund transfer module 308 communicatively coupled to the instruction input module 302. The monetary fund transfer module 308 is configured to handle movement of monies from electronic wallets to desired recipients in a desired manner. For example, steps 74, 76 of the method 50 can be carried out using the monetary fund transfer module 308.

Further illustration is now provided with two usage scenarios for the present invention.

Scenario 1

User A has a relationship with Bank XYZ. User A has booked three deposits with Bank XYZ, using their proprietary banking platform.

When User A wishes to use the present invention to place a new deposit for the first time, User A inputs parameters for deposit and is provided with a selection of available options from a plurality of depository institutions, showing, for example, interest rates being offered by each depository institution, credit rating of each depository institutions and so forth. For the sake of illustration, the selection is:

Bank “XYZ”—interest rate—7.75%, credit rating—AA+

Bank “PQR”—interest rate—7.75%, credit rating—AAA+

Bank “LMN”—interest rate—7.75%, credit rating—AAA+

Bank “UVW”—interest rate—8.25%, credit rating—A+

When User A is dissatisfied with the selection above, a request is submitted by User A for a special rate.

The present invention determines if User A has placed any prior deposits on the current platform. As User A has not placed any past deposits using the present invention, the present invention will only share the parameters of the presently offered deposit with depository institutions along with the special rate request. Consequent to the earlier illustration, Bank “PQR” and “LMN” agree to provide a special rate, say 8%. Given that their interest rates and credit ratings are better than “XYZ” and “UVW”, User A should typically decide to choose either Bank “PQR” or “LMN”.

When Bank “PQR” agrees to provide the special rate, the special rate details are stored in the data storage server on the payment gateway of the present invention. [The parameters are denoted as DEPOSIT1.]

If User A uses the present invention again to place a deposit and request a special rate, the present invention locates DEPOSIT1. The present invention then shares the presently offered deposit parameters and DEPOSIT 1 to depository institutions for them to consider the special rate request.

The method 50, system 200 or platform 300 enable users, preferably with electronic wallets, to access preferential rates for monetary deposits. In addition, the users can also enjoy conveniences brought about by not having to undergo extraneous verification procedures/processes when seeking monetary deposit products. Furthermore, the method 50, system 200 and platform 300 also allow depository institutions which provide electronic wallet facilities to their customers to provide new financial-related services and products to their customers. Moreover, the provision of preferential rates for monetary deposits for their customers also provide depository institutions an opportunity to understand a quantum of liquidity of their customers and pitch for the quantum of liquidity. In addition, it is also possible for the depository institutions to use the method 50, system 200 or platform 300 to entice users to invest their monies with the depository institutions or to raise the profiles of the depository institutions by providing preferential rates for monetary deposits.

While aforementioned embodiments relate to monetary deposit products, it should be appreciated that other products/services such as, for example, mortgage products, insurance products, personal loan products, investment products and the like can be offered to end users using the method 50, system 200 or platform 300. In this regard, the method 50, system 200 or platform 300 can be used by any corporate entities which provide the products/services offered to end users.

Whilst there have been described in the foregoing description preferred embodiments of the present invention, it will be understood by those skilled in the technology concerned that many variations or modifications in details of design or construction may be made without departing from the present invention.

1. A system for making a monetary deposit at a depository institution server, the system comprising:
at least one computing device configured for receiving instructions from a user; a payment gateway communicatively coupled to the at least one computing device; and
at least one data aggregator for aggregating monetary deposit offers from the payment gateway, the at least one data aggregator being communicatively coupled to the at least one computing device,
wherein the at least one data aggregator is configured to aggregate monetary deposit offers upon receipt of the instructions from the at least one computing device, the instructions including parameters pertaining to the monetary deposit, and parameters of prior monetary deposits associated with the user obtained from the payment gateway.

2. The system of claim 1, wherein the payment gateway includes a data storage device configured to store the parameters.

3. The system of claim 1, wherein the parameters are the monetary deposit amount and tenure of the monetary deposit.

4. A server configured for making a monetary deposit at a depository institution server, the server being configured to carry out a method comprising:
receiving from a user device, parameters pertaining to the monetary deposit;
obtaining updated deposit offers from respective servers of a plurality of depository institutions;
presenting to the user device, the updated deposit offers;
receiving from the user device, a request for improved deposit offers;
providing the respective servers of the plurality of depository institutions with information to obtain the improved deposit offers, the information being obtained from a payment gateway;
obtaining the improved deposit offers from the respective servers of the plurality of depository institutions; and
processing the improved deposit offers and presenting to the user device, the improved deposit offers from the respective servers of the plurality of depository institutions;
wherein the information includes the parameters pertaining to the monetary deposit and parameters of prior monetary deposits associated with a particular user.

5. The server of claim 4, being configured to carry out the method further comprising:
receiving at least one selection from the user device from amongst the improved deposit offers;
sending a request to the payment gateway to seek monies for the monetary deposit;
receiving a debit request from the payment gateway; and
receiving a confirmation of the monetary deposit from the server of at least one depository institution.

6. The server of claim 5, wherein the payment gateway includes a data storage device configured to store the parameters.

7. The server of claim 4, wherein the parameters are the monetary deposit amount and tenure of the monetary deposit.

8. A data processor implemented method for making a monetary deposit at a depository institution server, the method comprising:
receiving from a user device, parameters pertaining to the monetary deposit;
obtaining updated deposit offers from respective servers of a plurality of depository institutions;
presenting to the user device, the updated deposit offers;
receiving from the user device, a request for improved deposit offers;
providing the respective servers of the plurality of depository institutions with information to obtain the improved deposit offers, the information being obtained from a payment gateway;
obtaining the improved deposit offers from the respective servers of the plurality of depository institutions;
processing the improved deposit offers and presenting to the user device, the improved deposit offers from the respective servers of the plurality of depository institutions;
wherein the information includes the parameters pertaining to the monetary deposit and parameters of prior monetary deposits associated with a particular user.

9. The data processor implemented method of claim 8, further comprising:
receiving at least one selection from the user device from amongst the improved deposit offers;
sending a request to the payment gateway to seek monies for the monetary deposit;
receiving a debit request from the payment gateway; and
receiving a confirmation of the monetary deposit from the server of at least one depository institution.

10. The data processor implemented method of claim 9, wherein the payment gateway includes a data storage device configured to store the parameters.

11. The data processor implemented method of claim 8, wherein the parameters are the monetary deposit amount and tenure of the monetary deposit.
